(19) United States
(12) Patent Application Publication
(10) Pub. No.: US 2006/0065161 A1
(43) Pub. Date: Mar. 30, 2006

(54) Substrate coating compositions and their use

(76) Inventor: Gerald D. Miller, Humble, TX (US)

Correspondence Address: M. Susan Spiering;c/o Celanese Ltd., IP Legal Dept., IZIP 701, P.O. Box 428, Bishop, TX, 78343, US

(21) Appl. No.: 10/877,290

(22) Filed: Jun. 24, 2004

(51) Int. Cl. B32B 5/16; C04B 14/00

(52) U.S. Cl. 106/400; 106/628; 428/323

(57) ABSTRACT

Coating compositions, methods of applying the coating compositions, and articles incorporating the coating compositions are provided. The coating compositions are useful for coating a variety of substrates to improve the appearance and printability of the substrates. The coating compositions incorporate pigment system, a binder, and a thickener system. The thickener system incorporates a polyvinyl alcohol polymer and a boron containing compound such as boric acid. The coating compositions exhibit viscosity characteristics equal or superior to coating compositions incorporating conventional thickeners while providing cost advantages over conventional thickener systems.

### FIELD OF THE DISCLOSURE

This disclosure relates to pigmented substrate coating compositions and methods of making and using such compositions. The coating compositions incorporate a thickener system containing a polyvinyl alcohol polymer and a boron containing compound.

### BACKGROUND INFORMATION

In many product applications, substrates are provided with a coating to facilitate printing on the substrate and/or to improve the appearance of the substrate. An important purpose of a coating is to provide a smooth substrate surface that is substantially free of indentations or valleys. A smooth surface is necessary for printing good quality images on substrates and for effective transfer of ink to the substrate. A smooth substrate surface is obtained by coating the substrate surface with a pigment coating composition.

The coating composition is effectively an aqueous dispersion including mainly mineral pigments such as clay, calcium carbonate, or titanium oxide, and pigment binders of natural protein, for example, casein or soy protein, starch, or synthetic polymer emulsions. Coating compositions are usually applied to a continuous web of the substrate material by high speed coating machines, such as blade coaters, air knife coaters, rod coaters and roll coaters. The flow properties of coating color compositions for substrates are of significant importance with regard to the runnability (or flow) of the color during the coating operation. These flow properties are often controlled by a thickener.

Substrate coating compositions typically incorporate a pigment, a binder such as latex, and a thickener for strength, viscosity control, and water retention. The coating compositions may often also include additional components such optical brighteners, defoamers, crosslinkers, etc. The pigment is typically clay-based but may also include other pigment components such as calcium carbonate, titanium dioxide, and silica. Conventional co-binders or thickeners include starch, protein, and polyvinyl alcohol polymers.

U.S. Pat. No. 6,440,535 discloses the use of a polyvinyl alcohol copolymer as a thickener in an ink jet coating composition. U.S. Pat. No. 5,494,509 discloses clay pigment coating compositions incorporating a polysaccharide thickener. U.S. Pat. No. 6,746,713 discloses ink jet recording media coating incorporating a polyvinyl alcohol polymer and boric acid. The composition is used in the production of an ink absorption layer. U.S. Pat. No. 4,877,686 discloses an ink jet recording medium in which boric acid is used as a gelling agent for a binder incorporated into the medium. U.S. Pat. No. 3,438,808 discloses coating cellulosic fiberous webs with compositions incorporating polyvinyl alcohol and boric acid.

### BRIEF DESCRIPTION OF THE DISCLOSURE

This disclosure relates to coating compositions, methods of applying the coating compositions, and articles of commerce incorporating the coating compositions. The coating compositions described herein are useful for coating a variety of substrates to improve the appearance and printability of the substrates. The coating compositions incorporate a pigment system that may be selected from a variety of suitable systems, including clay, and a thickener system. The thickener system incorporates a polyvinyl alcohol polymer and a boron containing compound such as boric acid.

The thickener system is found to be useful to increase the viscosity of the coating composition through gelation and provides positive water retention characteristics. The thickener system is useful to provide an alternative to conventional thickener systems used in color coating compositions. The thickener system exhibits beneficial performance characteristics as well as provides attractive cost benefits, as compared to conventional thickener compositions.

In addition to the pigment and thickener systems, the coating compositions include a binder such latex, starch, protein, polyvinyl alcohol polymers, and mixtures thereof.

The coating compositions may also include a variety of additional components such as optical brighteners, defoamers, and other conventional additives.

Among the uses for the coating compositions are coating substrates such as paper and paperboard to provide a smooth printable surface on the substrate.

### DETAILED DESCRIPTION OF THE INVENTION

This disclosure relates to coating compositions and methods of applying and using the coating compositions. The coating compositions incorporate a unique thickener system that exhibits beneficial characteristics in comparison to coating compositions incorporating conventional thickeners. The coating compositions are generally aqueous solutions incorporating dissolved solids that include a pigment system, a binder, and a thickener system. In one embodiment, the aqueous coating compositions incorporate from about 60 wt. % to about 95 wt. % of total solids derived from of the pigment system, from about 4 wt. % to about 35 wt. % of total solids derived from the binder system, and from about 0.5 wt. % to about wt. % of total solids derived from the thickener system.

In one embodiment, the coating compositions comprise from about 40 wt. % to about 67 wt. % of total solids. In a second embodiment, the coating compositions comprise from about 45 wt. % to about 63 wt. % of total solids. In a third embodiment, the coating compositions comprise from about 50 wt. % to about 60 wt. % of total solids. The coating compositions may comprise from about 33 wt. % to about 60 wt. % water in one embodiment. In another embodiment, the coating compositions may comprise from about 38 wt. % to about 55 wt. % water. In a third embodiment, the coating compositions may comprise from about 40 wt. % to about 50 wt. % water.

The pigment system may be selected from any pigment system useful for substrate coating compositions. Exemplary suitable pigments are aqueous dispersions of coating grade clays, such as kaolin clays, titanium dioxide, calcium carbonate, barium sulfate, talc, zinc sulfate, aluminum sulfate, calcium oxide reaction products, other similar materials, and mixtures thereof. In one embodiment, the pigment system is comprised of at least 90 wt. % clay.

As noted above, the pigment system may comprise from about 60 wt. % to about 95 wt. % of the solids of the coating composition. In another embodiment, the pigment system may comprise about 70 wt. % to about 85 wt. % of the total solids of the coating composition, with the binder system comprising from about 4 wt. % to about 10 wt. % of the total solids of the composition, and with from about 0.5 wt. % to about 5 wt. % of the total solids of the composition derived from the thickener system.

The binder may be selected from any suitable binder useful for binding the pigment particles and other solids in the coating composition. Exemplary binders are natural protein materials such as casein or soy protein, starch, or synthetic polymer emulsions such as a latex material incorporating a styrene butadiene, acrylic latex, vinyl acetate latex, or styrene acrylic copolymers, or natural occurring latex materials, a polyvinyl alcohol polymer material.

The thickener system incorporates at least two components. A first component is a polyvinyl alcohol polymer and a second component is a boron containing compound. The polyvinyl alcohol polymer may be a homopolymer or a copolymer incorporating at least one co-monomer such as ethylene, methyl acrylate, a vinyl amine, a carboxylic acid, branched alkyl acid vinyl esters such as vinyl esters of alpha-branched carboxylic acids having 5 and 9 to 11 carbon atoms are available from Resolution Performance Products under the designations VeoVa®, vinyl amines, other co-monomers.

In one embodiment, the polyvinyl alcohol polymers useful in accordance with the compositions, products, and methods described herein have the following characteristics: a degree of polymerization of about 300 to about 4,000, a weight average molecular weight of about 10,000 to about 200,000, and is from about 85 mole % to about 99.9 mole % hydrolyzed. In another embodiment, thickener systems are produced with polyvinyl alcohol polymers having weight average molecular of weights about 124,000 to about 186,000.

The boron containing compound component for inclusion in the thickener system may be selected from a variety of materials. Exemplary suitable boron compounds are boric acid, methyl borate, boron trifluoride, boric anhydride, pyroborates, peroxoborates, boranes, and mixtures thereof. In one embodiment, the boron containing compound is boric acid. In another embodiment, the boron compound is sodium tetraborate decahydrate (borax). The boron compound may be added to the polyvinyl alcohol coating formulation or it may be applied as an aqueous solution overcoat to the already formed layer of polyvinyl alcohol.

The polyvinyl alcohol polymer and boron containing compound combination is useful as a thickener to control the viscosity of the coating composition. This viscosity regulation is provided by the formation of a complex between boric ion and hydroxyl groups in the polyvinyl alcohol polymer. At pH's above 8, the borate ion exists and is available to cross-link and cause gelling of the polyvinyl alcohol in the coating composition. At lower pH's, the borate is tied up by hydrogen and is not available for cross-linking, thus gelation caused by borate ion is reversible. By borating the polyvinyl alcohol, a gelled coating composition may be produced that can be easily applied to and and/or adhered to the substrate web.

As discussed above, in one embodiment, the total solids of the coating composition may be comprised of about 0.5 wt. % to about 5 wt. % of the thickener system solids. In another embodiment, the thickener systems solids comprise from about 1 wt. % to about 3 wt. % of the total solids of the coating composition. In turn, in one embodiment, the concentrations of the solids of the polyvinyl alcohol polymer and boron containing compound components of the thickener system may range from about 94 wt. % to about 99.98 wt. % and from about 0.02 wt. % to about 6 wt. % of the thickener system total solids, respectively. In another embodiment, the concentrations of the solids of the polyvinyl alcohol polymer and boron containing compound components range from about 96 wt. % to about 98 wt. % and about 2 wt. % to about 4 wt. % of the thickener system total solids, respectively.

In one embodiment, the boron containing compound may be incorporated into the coating composition at a concentration of from about 0.001 wt. % to about 0.03 wt. % solids, based upon the solids weight of the pigment component of the coating composition. In another embodiment, the boron containing compound may be incorporated into the coating formulations at a concentration of from about 0.015 wt. % to about 0.025 wt. % solids, based upon the total weight of the solids of the pigment component. In still another embodiment, the boron containing compound may be incorporated into the coating formulations at a concentration of from about 0.015 wt. % to about 0.02 wt. % solids, based upon the total weight of the solids of the pigment system.

The thickener systems described herein function as well or better than conventional thickeners such as protein, carboxymethylcellulose (CMC), sodium alginates, and alkali swellable or reactive polyacrylates. Moreover, the thickener systems described herein are available at much lower costs that these conventional thickeners, thereby providing substantial cost advantages for the manufacturer of the coating compositions.

However, the polyvinyl alcohol and boron containing compound thickener systems described herein may also be combined with conventional thickeners such as protein, carboxymethylcellulose (CMC), sodium alginates, and alkali swellable or reactive polyacrylates. When combined, the polyvinyl alcohol and boron containing compound thickener system comprises from about 50 wt. % to about 99 wt. % of the solids of the combined thickener system in one embodiment. In another embodiment, the polyvinyl alcohol and boron containing compound thickener system comprises from about 60 wt. % to about 80 wt. % of the solids of the combined thickener system.

The thickener systems described herein are useful to produce coating formulations having controllable viscosities over a wide range. In one embodiment, the viscosity of the coating formulation may be from about 2,700 cps to about 19,000. In another embodiment, the viscosity of the coating formulations may range from about 2,700 cps to about 10,0000 cps. In a third embodiment, the viscosity of the coating formulations may range about 2,700 cps to about 5,400 cps.

The thickener systems described herein are useful to produce coating formulations having controllable viscosities over a wide coating composition pH range. In one embodiment, the thickener systems are useful to control viscosity of the coating formulations over a pH range of 6.5 to 9.0. In another embodiment, the thickener systems are useful to control viscosity of the coating formulations over a pH range of 7.0 to 8.5.

Experimental Evaluations:

A control formulation having the following components was prepared:
(1) 83 parts of No. 1 clay
(2) 16 parts of ethylene vinylacetate latex (Airflex 100HS commercially available from Air Products and Chemicals, Inc.)
(3) 1 part of CELVOL 325 (viscosity of 28 cps to 32 cps @ 4% solids and 20° C., and a pH of 5.0 to 7.0, commercially available from Celanese Chemicals)
(4) A total solids concentration of 58% was targeted.

Using the Control formulation, the following studies were conducted:
(1) A 4% solution of Boric Acid (10 mol % bound water) was added to the Control formulation at 1, 1.5 and 2.0 percent based on dry parts CELVOL 325 (0.01%, 0.015%, and 0.02% boric acid based on pigment system solids). This procedure was repeated three-times to check reproducibility.
(2) Solutions of 2.0% NaOH and 1.75% NH₄OH were prepared as the pH controlling additives.
(3) A pH Ladder study with a range of 7.0 to 9.0 was conducted to observe pH effects on viscosity on the various formulations.

The Coating Formulations for studies #1 and #2 were prepared by the following method steps:
(1) The dilution water and defoamer were added first to the clay slurry.
(2) Latex, polyvinyl alcohol polymer, and boric acid were added under high-sheer mixing.
(3) The coating was mixed for an additional 10 minutes at 1500 rpm after the additions were completed.
(4) The initial pH was recorded and then adjusted to a pH of 7.3 under continuous mixing.
(5) After reaching the desired pH the coating color was mixed an additional 5 minutes.

The coating formulation for the pH ladder study discussed below was prepared by the previous method with the following exceptions:
(1) Master batch clay slurry with Airflex HS100, PVOH, and 2.0 percent boric acid (based on dry PVOH) was made.
(2) The pH of the slurries was adjusted with 2.0% NaOH to the following levels: 7.0, 7.5, 8.0, 8.5 and 9.0.

The formulations were checked for localized gels during and after high sheer mixing. Gels were not found in any of the boric acid levels. The following tests were run on each formulation: pH, microwave solids and Brookfield Viscosity at 60 rpm.

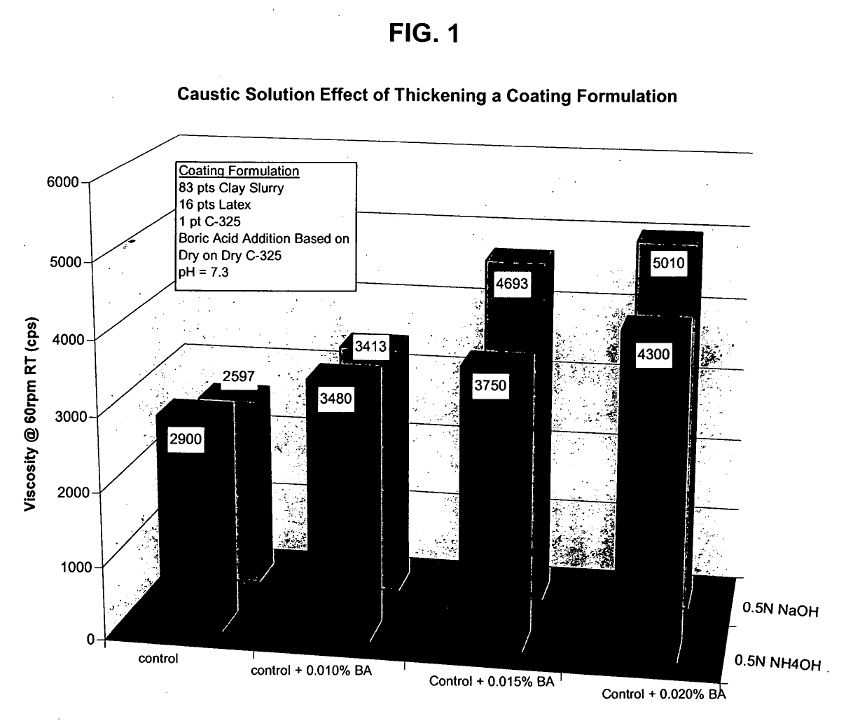

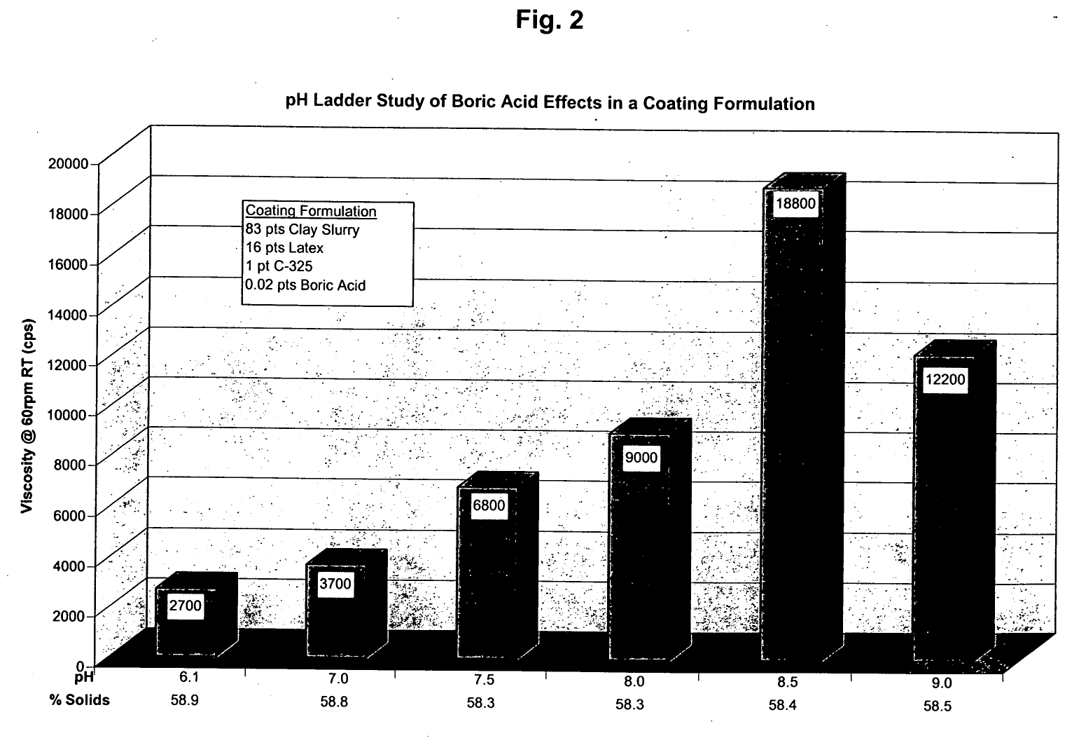

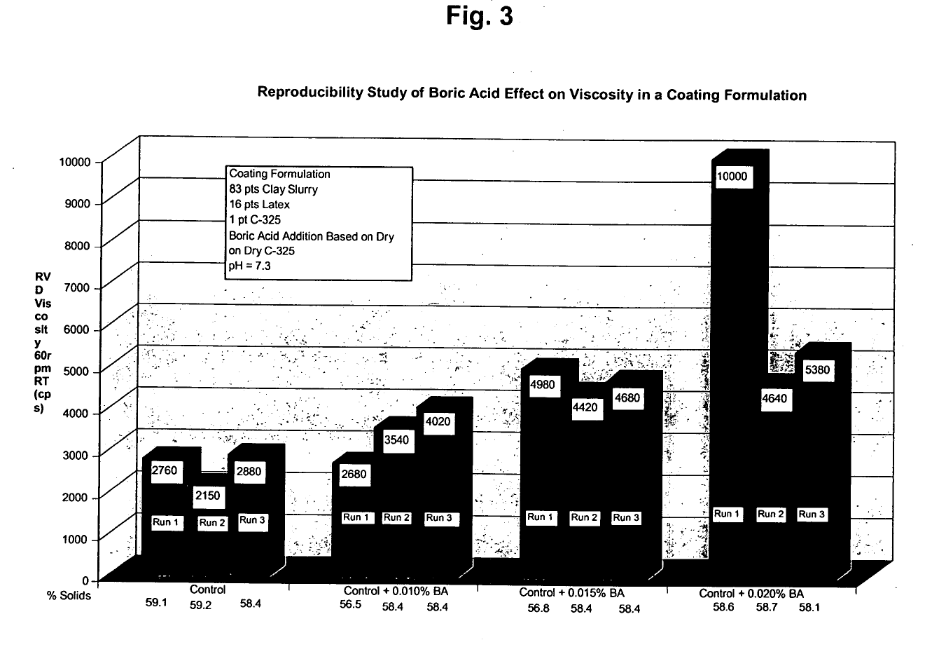

The results of the experimental evaluations are set out in FIG. 1, FIG. 2, and FIG. 3. FIG. 1 records the viscosity enhancing effects of adding a boron containing compound to the coating formulations. FIG. 2 demonstrates the variability of the viscosity of compositions to which the boron containing compound has be added in relation to the pH of the compositions. FIG. 3 records the reproducibility of the viscosity enhancing effects of adding a boron containing compound to the coating formulations.

As noted in FIG. 1, an increase in viscosity was noted for all of the boric acid addition levels that were evaluated. At 0.02% boric acid coating viscosities were 67% higher than the control with NH₄OH and 117% higher with NaOH.

With regard to the pH of the coating compositions, as discussed above, viscosity regulation is provided by the formation of a complex between boric ion and hydroxyl groups in the polyvinyl alcohol polymer. At pH's above 8, the borate ion exists and is available to cross-link and cause gelling of the polyvinyl alcohol in the coating composition. At lower pH's, the borate is tied up by hydrogen and is not available for cross-linking, thus gelation caused by borate ion is reversible. In the pH ladder study, the results of which are recorded in FIG. 2, the boric acid level was at a constant 0.02 wt. % of the weight of the pigment in the coating compositions. With reference to FIG. 3, it is seen that the viscosity of the coating compositions increases as the pH is increased up to 8.5. From this data, it concluded that a pH range of 7.0 to 8.5 is desirable in one embodiment of the coating compositions described herein.

FIG. 3 reports the repeatability of the performance of the coating compositions described with respect to FIG. 1. As seen in FIG. 3 the coating compositions exhibited consistency of viscosity performance each time the coating compositions were produced. It is seen that the fourth data set shows a very high viscosity for a coating composition at a solids content of 58.6. It is believed that this viscosity value, that is much higher than the other viscosity values, resulted from a formulation error or viscosity measurement error.

All patents and publications referred to herein are hereby incorporated by reference in their entireties.

Although the present invention and its advantages have been described in detail, it should be understood that various changes, substitutions, and alterations could be made without departing from the spirit and scope of the invention as defined by the following claims.

1-20. (canceled)

21. A substrate coating composition comprising:
(a) a pigment system comprising about 60 wt. % to about 95 wt. % of total solids of the coating composition;
(b) a binder comprising about 4 wt. % to about 35 wt. % of total solids of the coating composition;
(c) a thickener system comprising about 0.5 wt. % to about 5 wt. % of total solids of the coating composition comprising:
(i) a polyvinyl alcohol polymer having a degree of polymerization of about 300 to about 4,000, a molecular weight of about 10,000 to about 200,000, and being about 88.0 mole % to about 99.9 mole % hydrolyzed, comprising about 94 wt. % to about 99.98 wt. % of total solids of the thickener system; and
(ii) a boron containing compound comprising about 0.02 wt. % to about 6 wt. % of total solids of the thickener system, wherein the coating composition comprises from about 40 wt. % to about 67 wt. % total solids.

22. The substrate coating composition of claim 21 having a viscosity of about 2,700 cps to about 10,000 cps.

23. The substrate coating composition of claim 22 wherein the boron containing compound is present in a concentration of about 0.001 wt. % to about 0.03 wt. % of the solids of the pigment system.

24. The substrate coating composition of claim 22 wherein the pigment system comprises a material selected from the group consisting of clay, titanium dioxide, calcium carbonate, barium sulfate, talc, zinc sulfate or the reaction product of aluminum sulfate, calcium oxide, and mixtures thereof and wherein the binder comprises latex.

25. The substrate coating composition of claim 24 having a pH of 7.0 to 8.5.

26. The substrate coating composition of claim 25 comprising from about 33 wt. % to about 60 wt. % water.

27. The substrate coating composition of claim 26 having a total solids content of about 45 wt. % to about 63 wt. %.

28. The substrate coating composition of claim 27 wherein the boron containing compound is boric acid and is present at a concentration of 0.01 wt. % to 0.025 wt. % of the total solids of the pigment system.

29. The substrate coating composition of claim 28 wherein the pigment system comprises about 70 wt. % to about 85 wt. % of the total solids of the coating composition and wherein the pigment system comprises at least 90 wt. % clay and wherein the polyvinyl alcohol polymer has a molecular weight of about 124,000 to about 186,000.

30. The substrate coating composition of claim 29 wherein the binder comprises latex.

31. The substrate coating composition of claim 24 wherein a material selected from the group consisting of protein, carboxymethyl cellulose, sodium alginates, polyacrylates, and mixtures thereof comprises about 20 wt. % to about 40 wt. % of the solids of the thickener system.

32. A coated substrate comprising:
(1) a substrate; and
(2) a coating comprising:
(a) a pigment system comprising about 60 wt. % to about 95 wt. % of total solids of the coating composition;
(b) a binder comprising about 4 wt. % to about 35 wt. % of total solids of the coating composition;
(c) a thickener system comprising about 0.5 wt. % to about 5 wt. % of total solids of the coating composition comprising:
(i) a polyvinyl alcohol polymer having a degree of polymerization of about 300 to about 4,000, a molecular weight of about 10,000 to about 200,000, and being about 88.0 mole % to about 99.9 mole % hydrolyzed, comprising about 94 wt. % to about 99.98 wt. % of total solids of the thickener system; and
(ii) a boron containing compound comprising about 0.02 wt. % to about 6 wt. % of total solids of the thickener system,
wherein the coating composition comprises from about 40 wt. % to about 67 wt. % total solids.

33. The coated substrate of claim 32 wherein the substrate is selected from the group consisting of paperboard and paper.

34. The coated substrate of claim 33 wherein the boron containing compound is boric acid present at a concentration of about 0.01 wt. % to about 0.03 wt. % of the solids of the pigment system.

35. The coated substrate of claim 34 wherein the pigment system comprises a material selected from the group consisting of clay, titanium dioxide, calcium carbonate, barium sulfate, talc, zinc sulfate or the reaction product of aluminum sulfate, calcium oxide, and mixtures thereof.

36. The coated substrate of claim 35 wherein the boric acid is present at a concentration of 0.01 wt. % to 0.025 wt. % of the solids of the pigment system.

37. The coated substrate of claim 36 wherein the pigment system comprises at least 90 wt. % clay and wherein the polyvinyl alcohol polymer has a molecular weight of about 124,000 to about 186,000.

38. The coated substrate of claim 37 wherein the substrate is comprised of paperboard.

39. A process of coating a substrate comprising:
(1) coating the substrate with a coating composition comprising:
(a) a pigment system comprising about 60 wt. % to about 95 wt. % of total solids of the coating composition;
(b) a binder comprising about 4 wt. % to about 35 wt. % of total solids of the coating composition;
(c) a thickener system comprising about 0.5 wt. % to about 5 wt. % of total solids of the coating composition comprising:
(i) a polyvinyl alcohol polymer having a degree of polymerization of about 300 to about 4,000, a molecular weight of about 10,000 to about 200,000, and being about 88.0 mole % to about 99.9 mole % hydrolyzed, comprising about 94 wt. % to about 99.98 wt. % of total solids of the thickener system; and
(ii) a boron containing compound comprising about 0.02 wt. % to about 6 wt. % of total solids of the thickener system,
wherein the coating composition comprises from about 40 wt. % to about 67 wt. % total solids; and
drying the coating composition.

40. A printed substrate product comprised of a coated substrate comprising:
(a) a pigment system comprising about 60 wt. % to about 95 wt. % of total solids of the coating composition;
(b) a binder comprising about 4 wt. % to about 35 wt. % of total solids of the coating composition;
(c) a thickener system comprising about 0.5 wt. % to about 5 wt. % of total solids of the coating composition comprising:
(i) a polyvinyl alcohol polymer having a degree of polymerization of about 300 to about 4,000, a molecular weight of about 10,000 to about 200,000, and being about 88.0 mole % to about 99.9 mole % hydrolyzed, comprising about 94 wt. % to about 99.98 wt. % of total solids of the thickener system; and
(ii) boric acid comprising about 0.02 wt. % to about 6 wt. % of total solids of the thickener system.
